(19) United States
(12) Patent Application Publication
(10) Pub. No.: US 2022/0194302 A1
(43) Pub. Date: Jun. 23, 2022

(54) VEHICLE RACK

(71) Applicant: Larry's Ski Racks LLC, Aspen, CO (US)

(72) Inventor: Robert Howard Myers, Carbondale, CO (US)

(21) Appl. No.: 17/125,289

(22) Filed: Dec. 17, 2020

(51) Int. Cl. B60R 9/12

(52) U.S. Cl. CPC B60R 9/12

(57) ABSTRACT

A vehicle rack can carry multiple pairs of skis and/or multiple snowboards in an upright orientation. The rack has multiple tubes, each sized to at least partially receive a pair of skis therein. The tubes can be arranged in multiple nested rows. The rack can have a housing sized to receive one or more snowboards at least partially therein. The rack can directly couple to a vehicle hitch or to a swing arm previously coupled to the vehicle hitch.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to a vehicle rack, and more particularly to a vehicle rack for carrying skis and/or snowboards.

### Description of the Related Art

Vehicle racks are used to carry different cargo that may not fit in the vehicle or to free up space in the vehicle. Existing racks can mount to the top or rear of the vehicle. However existing racks are limited in the number of items they can carry, or are only built to carry one type of item (e.g., carry only skis). Another drawback of existing racks is that they can be cumbersome and prevent users from easily accessing the cargo in the rack.

### SUMMARY

In accordance with one aspect of the disclosure, a vehicle rack is provided that can carry multiple (e.g., more than two, such as three, four, five, six, seven) pairs of skis.

In accordance with one aspect of the disclosure, a vehicle rack is provided that can carry multiple (e.g., more than two, such as three, four, five, six, seven) pairs of skis in a substantially upright orientation and so that the skis are self-supported on the rack.

In accordance with another aspect of the disclosure, a vehicle rack is provided that can carry multiple (e.g., more than two, such as three, four, five) pairs of skis as well as carry one or more snowboards.

In accordance with another aspect of the disclosure, a vehicle rack is provided that can carry multiple (e.g., more than two, such as three, four, five) pairs of skis as well as carry one or more snowboards in a substantially upright orientation and so that the skis and snowboards are self-supported on the rack.

In accordance with another aspect of the disclosure, a vehicle rack for carrying a pair of skis and/or a snowboard is provided. The rack comprises a hitch connector extending in a first direction, the hitch connector configured to directly connect or operatively connect to a hitch of a vehicle. The rack also comprises a support platform disposed above the hitch connector and extending along a plane, a plurality of holes defined through the support platform. Additionally, the rack comprises a plurality of tubes disposed above and supported on the support platform, each of the tubes extending substantially perpendicular to the plane of the support platform and surrounding one of the plurality of holes. Each of the tubes is sized to receive at least partially therein a pair of skis so that the pair of skits are supported by the tubes and support platform, the plurality of holes configured to drain water or snow from within the tubes.

In accordance with another aspect of the disclosure, a vehicle rack for carrying a pair of skis and/or a snowboard is provided. The rack comprises a hitch connector extending in a first direction, the hitch connector configured to directly connect or operatively connect to a hitch of a vehicle. The rack also comprises a support platform disposed above the hitch connector and extending along a plane, one or more holes defined through the support platform. Additionally, the rack comprises a plurality of tubes disposed above and supported on the support platform and extending to a proximal open end that defines a top end of the rack, each of the tubes extending substantially perpendicular to the plane of the support platform. Each of the tubes is sized to receive at least partially therein a pair of skis so that the pair of skits are supported by the tubes and support platform, the one or more holes configured to drain water or snow from within the tubes. Optionally, the rack includes a housing sized to receive at least partially therein a snowboard so that the snowboard is supported by the housing and the support platform.

### BRIEF DESCRIPTION OF THE DRAWINGS

FIG. 1 shows a front view of a vehicle rack.

FIG. 2 shows a right side view of the vehicle rack of FIG. 1, the left side view being a mirror image.

FIG. 3 shows a top view of the vehicle rack of FIG. 1.

FIG. 4 shows a bottom view of the vehicle rack of FIG. 1.

FIG. 5 shows a rear view of the vehicle rack of FIG. 1.

FIG. 6 shows a top perspective view of the vehicle rack of FIG. 1.

FIG. 7 shows a front view of a vehicle rack.

FIG. 8 shows a right side view of the vehicle rack of FIG. 7, the left side view being a mirror image.

FIG. 9 shows a top view of the vehicle rack of FIG. 7.

FIG. 10 shows a bottom view of the vehicle rack of FIG. 7.

FIG. 11 shows a rear view of the vehicle rack of FIG. 7.

FIG. 12 shows a top perspective view of the vehicle rack of FIG. 7.

### DETAILED DESCRIPTION

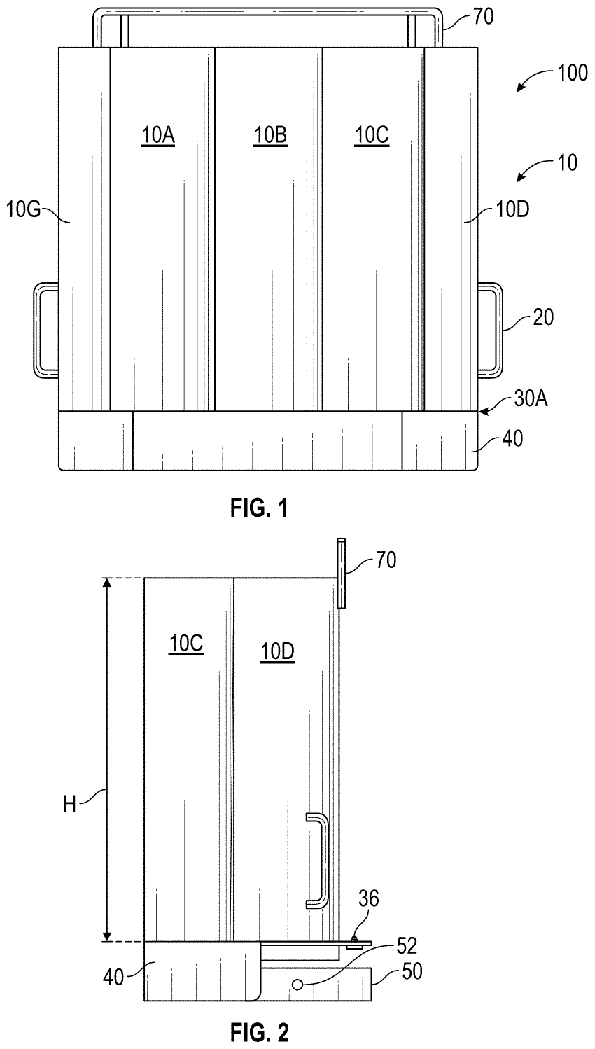

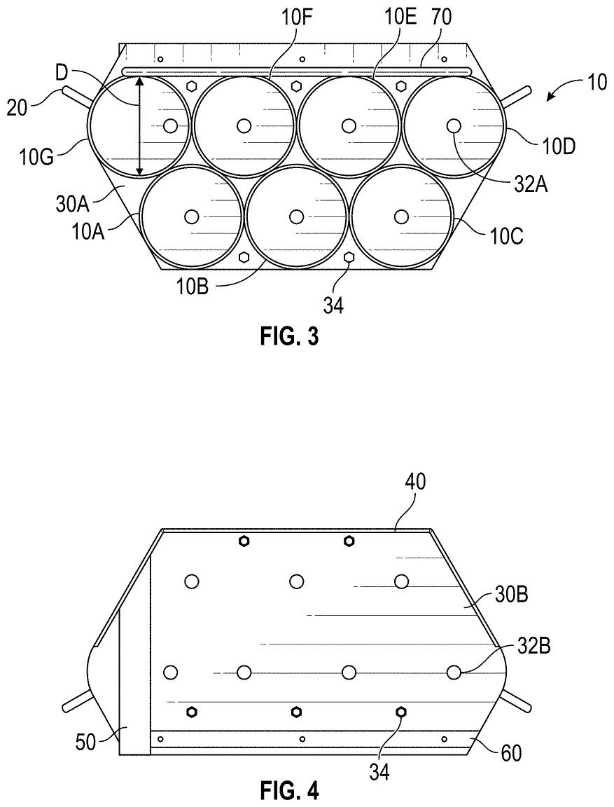

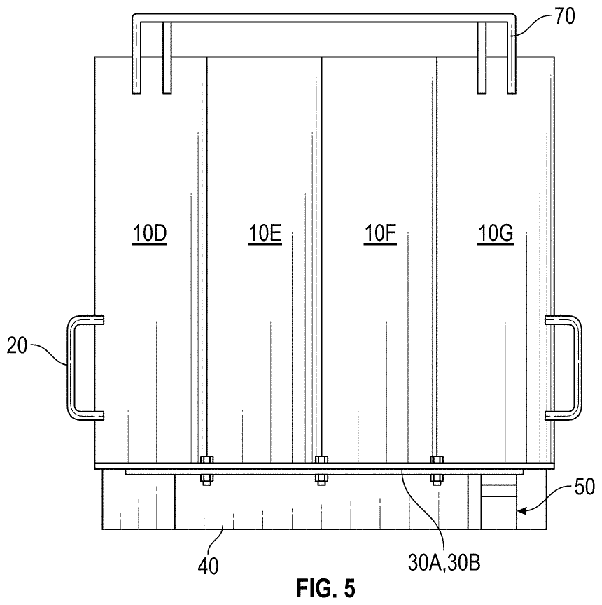

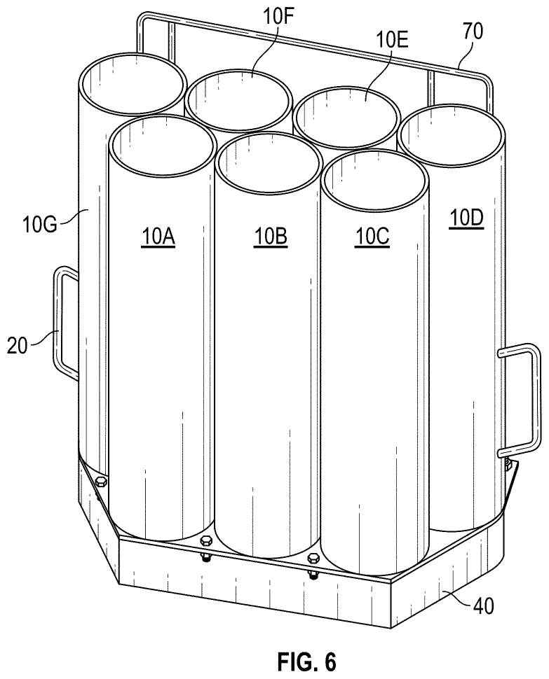

FIGS. 1-6 show a vehicle rack 100. In one implementation, the vehicle rack 100 can be coupled directly to a hitch of a vehicle (e.g., car, truck, van, RV), as further discussed below. In another implementation, the vehicle rack 100 can be operatively coupled to a hitch of a vehicle, such as by coupling the rack 100 to a swing arm that has previously been coupled to a hitch of a vehicle. With reference to FIG. 2, the rack 100 can have a height of between about 20 inches and about 40 inches, such as between about 25 inches and about 30 inches, such as about 27 inches. With reference to FIG. 3, the rack 100 can have a width of between about 20 inches and about 40 inches, such as between about 25 inches and about 30 inches, such as about 27 inches. With reference to FIG. 3, the rack 100 can have a depth of between about 10 inches and about 20 inches, such as about 12 inches.

The rack 100 includes a plurality of tubes 10. In one implementation, the tubes 10 are cylindrical (e.g., have a circular cross-section). However, in other implementations, the tubes 10 can have other suitable shapes (e.g., square cross-section, rectangular cross-section). The plurality of tubes 10 are arranged in multiple rows. The rows of tubes 10 can have the same number of tubes 10, or different number of tubes 10 in each row. The rows of tubes 10 can have an even number of tubes 10, or an odd number of tubes 10. As shown in FIG. 3, the tubes 10 can be arranged in two rows, with a front row having three tubes 10A, 10B, 10C and a rear row having four tubes 10D, 10E, 10F, 10G. The tubes 10A, 10B, 10C in the front row can be staggered or offset relative to the tubes 10D, 10E, 10F, 10G so that the tubes 10A, 10B, 10C are nested relative to the tubes 10D, 10E, 10F, 10G, which advantageously results in a more compact structure and conserves space. Each of the tubes 10 is sized (e.g., have a height H and inner diameter D) to at least partially receive therein a pair of skis. The inner diameter D can be between about 5 inches and about 10 inches. In some implementations the inner diameter D can be between about 6 inches and about 7 inches, such as between about 6¼ inches and about 6½ inches. The tube(s) 10 can have other suitable inner diameter D values (e.g., sized to at least partially receive a pair of skis therein). In some implementations, the height H can be equal to or greater than half the length of the skis (e.g., about 50%, about 60%, about 70% about 80%, about 90%, approximately 100% of the length of the skis). The height H can be between about 15 inches and about 36 inches. In some implementations, the height H can be between about 20 inches and about 30 inches, such as between about 20 inches and 25 inches or about 23 inches. The tubes 10 can be made of metal, such as aluminum, allowing them to be relatively light weight. However, the tubes 10 can be made of other suitable materials. Optionally, the tubes 10 can be coupled to each other. In one embodiment, two or more of the tubes 10 can be coupled (e.g. welded) to each other along at least a portion of their lengths (e.g., along edges that contact each other, as shown in FIG. 3).

The tubes 10 can be mounted on a base 30A. For example, ends of the tubes 10 can be welded to an upper surface of the base 30A. The base 30A can be substantially planar (e.g., flat). Optionally, the base 30A can have an outer perimeter that at least partially follows the nested configuration of the rows of tubes 10, as shown in FIG. 3 to provide a compact structure. The base 30A has one or more holes 32A defined through the base 30. The tubes 10 are disposed on the base 30A so that each tube 10 surrounds at least one hole 32A, as shown in FIG. 3. The one or more holes 32A advantageously drain water and/or snow from within the tubes 10 (e.g., when snow on the skis that are placed in the tubes melt). In one implementation, the base 30A can be made of aluminum, allowing it to be relatively light weight. However, the base 30A can be made of other suitable materials.

Optionally, a support plate 30B is disposed below the base 30A and coupled to the base 30A with one or more fasteners 34. The support plate 30B can include a planar (e.g., flat) portion and have holes 32B that align with the holes 32A to provide a drain for each of the tubes 10. Optionally, the support plate 30B can have substantially the same (e.g., the same) outer perimeter as the base 30A. The support plate 30B can have a flange 40 that extends generally transverse (e.g., perpendicular) to the base 30A and defines at least a portion of a front surface of the rack 100. Optionally, the support plate 30B can be made of steel. However, the support plate 30B can be made of other suitable materials. The support plate 30B can be coupled to (e.g., welded) to a receiver hitch assembly (e.g., the hitch connector 50). The base 30A can couple (e.g., bolt) to the support plate 30B, as shown for example in FIG. 5. Advantageously, the same support plate 30B (coupled to the hitch connector 50) can be coupled (e.g., bolted) to the base 30A of the rack 100 (for skis) or to the base 30A′ of the rack 100′ (for skits and snowboards), described further below.

The rack 100 has a hitch connector 50 with one or more holes 52 therethrough sized to receive a hitch lock or bolt when the hitch connector 50 is coupled to the vehicle (e.g., directly coupled to the hitch (not shown) on the vehicle, or operatively coupled to the vehicle via a swing or pivot arm coupled the the hitch of the vehicle) to lockingly couple (directly or indirectly) the rack 100 to the vehicle. The hitch connector 50 can be a tube and can have a generally square cross-section. In other implementations, the hitch connector 50 can have other suitable shapes or cross-sections that facilitate its coupling to a vehicle hitch or to a swing or pivot arm coupled to the vehicle hitch. The hitch connector 50 is disposed under the support plate 30B. The hitch connector 50 can be coupled to the underside of the support plate 30B. For example, the hitch connector 50 can be welded to the underside of the support plate 30B. Optionally, the hitch connector 50 can be of the same material as the support plate 30B. In one implementation, the hitch connector 50 is made of steel. However, the hitch connector 50 can be made of other suitable materials. The hitch connector 50 is offset from a centerline of the rack 100 extending across the front and rear rows of the tubes 10. Advantageously, the hitch connector 50 is offset to facilitate interfacing with a pivot assembly (e.g., of a swing arm coupled to the vehicle and to which the rack 100 couples). In another implementation, the hitch connector 50 can extend along the centerline of the rack 100 that extends across the front and rear rows of the tubes 10.

The rack 100 can further include a stability strip 60 below the support plate 30B at a location rearward of the tubes 10D, 10E, 10F, 10G. The stability strip 60 can be coupled to the support plate 30B and/or base 30A with fasteners 36. The stability strip 60 advantageously aids in reducing wear between the support plate 30B and a swinging plate (e.g., of a swing arm coupled to the vehicle and to which the rack 100 couples). In one implementation, the stability strip 60 can be or can include a shim and a pad that inhibits (e.g., prevents) squeaking and wear caused by vibration during operation (e.g., driving) of the vehicle to which the rack 100 is operatively coupled.

The rack 100 has one or more (e.g., a pair of) handles 20 to facilitate handling of the rack 100. As shown in FIGS. 1-6, in one implementation the one or more handles 20 can be a pair of handles 20 attached to tubes 10D, 10G on the rear row of tubes 10. The rack 100 can also have a support bar or handle 70 attached to and extending above and behind the rear row of tubes 10 (e.g., attached to tubes 10D, 10G). The handle 70 advantageously allows the skis and/or snowboards to be locked to the rack 100, 100′, such as with a bicycle cable lock, to deter theft of the skis and/or snowboards carried by the rack 100, 100′.

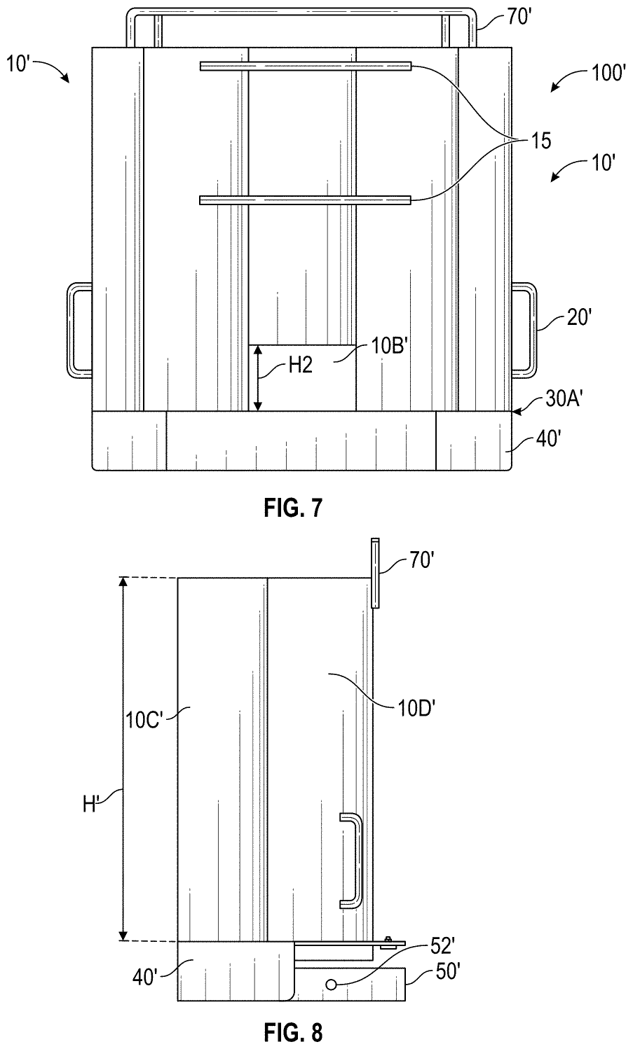

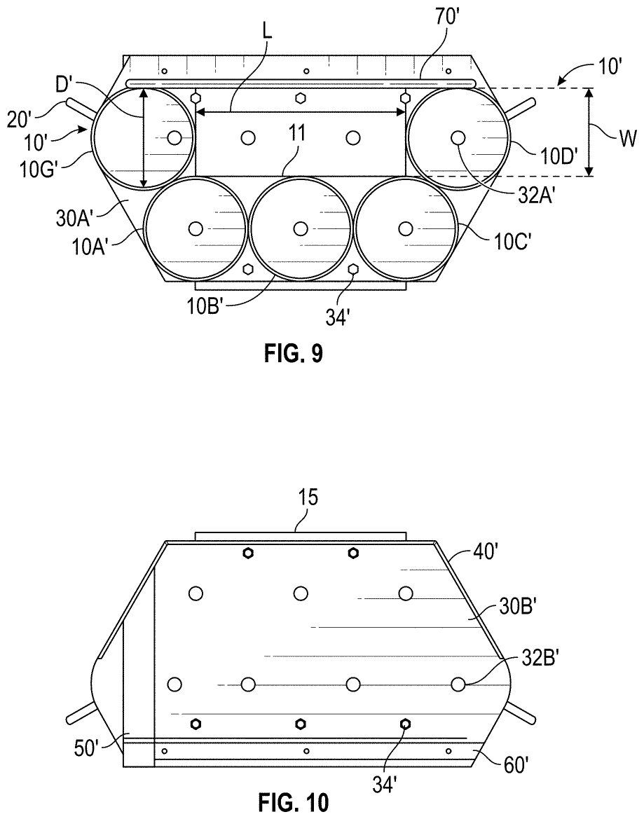

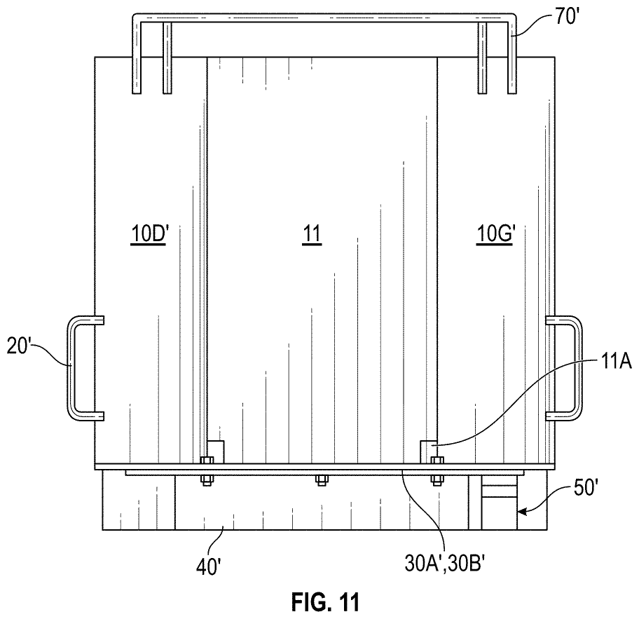

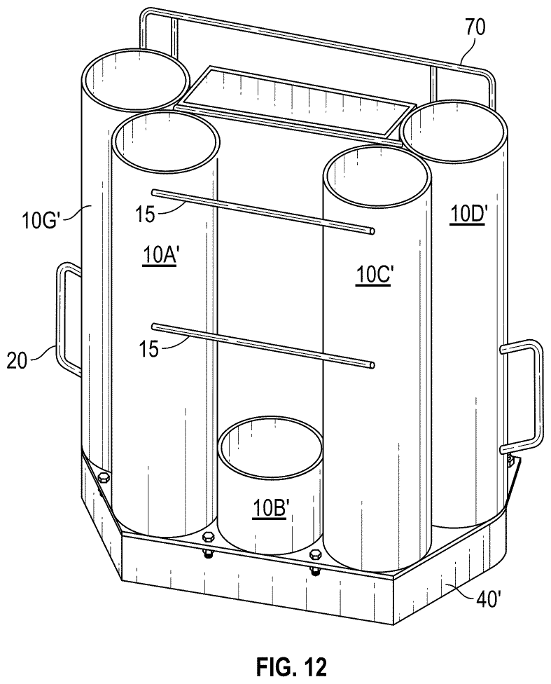

FIGS. 7-12 illustrates a vehicle rack 100′. Some of the features of the vehicle rack 100′ are similar to features of the vehicle rack 100 in FIGS. 1-6. Thus, references numerals used to designate the various components of the vehicle rack 100′ are identical to those used for identifying the corresponding components of the rack 100 in FIGS. 1-6, except that a “′” has been added to the numerical identifier. Therefore, the structure and description for the various features of the vehicle rack 100 in FIGS. 1-6 are understood to also apply to the corresponding features of the vehicle rack 100′ in FIGS. 7-12, except as described below.

The rack 100′ differs from the rack 100 in that it replaces two tubes 10E, 10F with a housing 11 that is generally rectangular in cross-section on the rear row of tubes 10. The housing 11 has a width W and length L sized to at least partially receive one or more (e.g., two) snowboards therein. In one implementation, the width W can be between about 4 inches and 6 inches, such as approximately 5½ inches. In one implementation the length L can be between about 10 inches and about 15 inches, such as approximately 13 inches. In one implementation, the housing 11 can have the same height H′ as some of the tubes 10. In another implementation, the housing 11 can be shorter many of the tubes 10. For example, a height of the housing 11 can be equal to or greater than half the length of the snowboard (e.g., about 50%, about 60%, about 70% about 80%, about 90%, approximately 100% of the length of the snowboard).

Another difference between the rack 100′ and the rack 100 is that the tube 10B has a height H2 that is shorter than height H′ of the rest of the tubes 10 and one or more (e.g., a pair of) bars 15 extend across a space between and couple to tubes 10A′, 10C′. The bars 15 are coupled (e.g., welded) to the tubes 10A′, 10C′. In one implementation, the bars 15 can have a round or circular cross-section. However, the bards 15 can have other suitable configurations (e.g., a square or rectangular cross-section). The bars 15 can be made of aluminum. However, the bars 15 can be made of other suitable materials. Advantageously, the bars 15 provide structural support to the tubes 10A′, 10C′ and allow the space between the tubes 10A′, 10C′ to accommodate one or more snowboards (e.g., two snowboards back to back) therein and the snowboard bindings. Additionally, the bars 15 aid in supporting a pair of skis (and/or poles) that are at least partially inserted into the tube 10B to keep them from inadvertently falling out of the rack 100′.

Advantageously, the rack 100 can carry multiple (e.g., more than two, such as three, four, five, six, seven) pairs of skis in a substantially upright orientation and so that the skis are self-supported on the rack. The rack 100′ advantageously can carry multiple (e.g., more than two, such as three, four, five) pairs of skis as well as carry one or more (e.g., two) snowboards. Accordingly, the rack 100, 100′ provide increased carrying capacity of skis and/or snowboards, as well as provide for a compact form factor. Additionally, the rack 100, 100′ allow the skis and/or snowboards to be self-supported (under gravity) within the tubes 10, 10′ or housing 11, making it easy for uses to position skis and snowboards on the rack 100, 100′ as well as making it easy to remove them since no additional strap or lock needs to be used to support the skis and/or snowboards on the rack 100, 100′. Further, the rack 100, 100′ can advantageously be coupled directly to the hitch on a vehicle (e.g., car, truck, van, RV) or indirectly coupled to the vehicle by coupling the rack 100, 100′ to a swing or pivot arm previously coupled to the hitch on a vehicle.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, less than or equal to 10 degrees, less than or equal to 5 degrees, less than or equal to 3 degrees, less than or equal to 1 degree, or less than or equal to 0.1 degree. As another example, in certain embodiments, the terms “generally perpendicular” and “substantially perpendicular” refer to a value, amount, or characteristic that departs from exactly perpendicular (i.e., 90 degrees) by less than or equal to 15 degrees, less than or equal to 10 degrees, less than or equal to 5 degrees, less than or equal to 3 degrees, less than or equal to 1 degree, or less than or equal to 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A vehicle rack for carrying a pair of skis and/or a snowboard, comprising:
a hitch connector extending in a first direction, the hitch connector configured to directly connect or operatively connect to a hitch of a vehicle;
a support platform disposed above the hitch connector and extending along a plane, a plurality of holes defined through the support platform;
a plurality of tubes disposed above and supported on the support platform, each of the tubes extending substantially perpendicular to the plane of the support platform and surrounding one of the plurality of holes, each of the tubes sized to receive at least partially therein a pair of skis so that the pair of skits are supported by the tubes and support platform, the plurality of holes configured to drain water or snow from within the tubes.

2. The vehicle rack of claim 1, wherein the hitch connector is laterally offset relative to a centerline of the support platform.

3. The vehicle rack of claim 1, wherein the plurality of tubes are coupled to each other.

4. The vehicle rack of claim 3, wherein the plurality of tubes are welded to each other.

5. The vehicle rack of claim 1, wherein the plurality of tubes have a cylindrical shape with a substantially circular cross-section.

6. The vehicle rack of claim 1, wherein the plurality of tubes are arranged in two adjacent rows.

7. The vehicle rack of claim 6, wherein the tubes in a first row of the adjacent rows are laterally offset from the tubes in the second row so that the tubes in the first and second rows are arranged in a nested configuration.

8. The vehicle rack of claim 1, further comprising an housing disposed above and supported on the support platform, the housing extending substantially perpendicular to the plane of the support platform and surrounding at least one of the plurality of holes, the housing sized to receive at least partially therein a snowboard so that the snowboard is supported by the housing and the support platform.

9. The vehicle rack of claim 8, wherein the housing has a substantially rectangular cross-section.

10. The vehicle rack of claim 8, wherein the plurality of tubes are arranged in two adjacent rows and at least partially surround the housing.

11. A vehicle rack for carrying a pair of skis and/or a snowboard, comprising:
a hitch connector extending in a first direction, the hitch connector configured to directly connect or operatively connect to a hitch of a vehicle;
a support platform disposed above the hitch connector and extending along a plane, one or more holes defined through the support platform;
a plurality of tubes disposed above and supported on the support platform and extending to a proximal open end that defines a top end of the rack, each of the tubes extending substantially perpendicular to the plane of the support platform, each of the tubes sized to receive at least partially therein a pair of skis so that the pair of skits are supported by the tubes and support platform, the one or more holes configured to drain water or snow from within the tubes.

12. The vehicle rack of claim 1, wherein the hitch connector is laterally offset relative to a centerline of the support platform.

13. The vehicle rack of claim 1, wherein the plurality of tubes are coupled to each other.

14. The vehicle rack of claim 13, wherein the plurality of tubes are welded to each other.

15. The vehicle rack of claim 11, wherein the plurality of tubes have a cylindrical shape with a substantially circular cross-section.

16. The vehicle rack of claim 11, wherein the plurality of tubes are arranged in two adjacent rows.

17. The vehicle rack of claim 16, wherein the tubes in a first row of the adjacent rows are laterally offset from the tubes in the second row so that the tubes in the first and second rows are arranged in a nested configuration.

18. The vehicle rack of claim 11, further comprising an housing disposed above and supported on the support platform, the housing extending substantially perpendicular to the plane of the support platform, the housing sized to receive at least partially therein a snowboard so that the snowboard is supported by the housing and the support platform.

19. The vehicle rack of claim 18, wherein the housing has a substantially rectangular cross-section.

20. The vehicle rack of claim 18, wherein the plurality of tubes are arranged in two adjacent rows and at least partially surround the housing.
